(19) United States
(12) Patent Application Publication
(10) Pub. No.: US 2005/0141013 A1
(43) Pub. Date: Jun. 30, 2005

(54) Redirect-on-error print system, information processing apparatus, control method, and control program

(75) Inventors: Koji Kikuchi, Yokohama (JP); Noriyoshi Kurotsu, Yokohama (JP); Masamichi Ohshima, Tokyo (JP); Hidekazu Morooka, Kawasaki (JP); Takashi Yagita, Yokohama (JP); Koichiro Wanda, Yokohama (JP); Kei Kitagata, Yokohama (JP); Hiroyuki Kayama, Kawasaki (JP); Kenichi Shirai, Yokohama (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/999,989

(22) Filed: Dec. 1, 2004

(30) Foreign Application Priority Data
Dec. 3, 2003 (JP) 2003-405029

(51) Int. Cl. G06F 15/00

(52) U.S. Cl. 358/1.14; 358/1.15

(57) ABSTRACT

In a redirect-on-error print system of this invention, when an error notification is acquired, only printer drivers having the same function as that of the printer driver which has output the data to the printer with the print error are listed up from registered printer drivers, and the user is caused to select a redirect-on-error print destination from them so that any inappropriate print output can reliably be avoided. In the redirect-on-error print system, a print job is transmitted to one of a plurality of printers connected to a network. When a print error has occurred in the printer, processing is executed to cause another printer to execute redirect-on-error printing of the print job. In the redirect-on-error print system, the error in the printer which is processing the print job is detected, and the user is notified of it. Of the plurality of printers connected to the network, the printer driver of a redirect-on-error enable printer which can process the print job in behalf of the printer with the error is detected. The user is notified of the detected printer driver as a redirect-on-error destination candidate.

### FIELD OF THE INVENTION

The present invention relates to a print processing technique using a plurality of printers and, more particularly, to a method of displaying, on a personal computer, error information in redirect-on-error printing when a print error has occurred in a printing apparatus which has received a print instruction from a data supply source such as a personal computer connected to a network.

### BACKGROUND OF THE INVENTION

Recently, connecting printing apparatuses to a network is a commonly used technique. Accordingly, many printing apparatuses can be connected to a network and used. Under these circumstances, even if a print error has occurred in a printing apparatus to which a print instruction is input, the print user can quickly use print information by temporarily outputting unprinted print job information to another printing apparatus instead of immediately avoiding the print error. That is, a “redirect-on-error print” function is implemented.

For example, there is a method in which it is determined whether automatic redirect-on-error printing is set. If it is determined that automatic redirect-on-error printing is set, automatic redirect-on-error printing is executed. If it is determined that the setting is not done, manual redirect-on-error printing is executed. In this way, automatic redirect-on-error printing and manual redirect-on-error printing are switched.

In this “redirect-on-error print function”, however, when a print error has occurred in a print-instructed printing apparatus, and manual redirect-on-error printing is executed to designate a redirect-on-error print destination, all the currently registered printer drivers are displayed as candidates to select a printer driver as the redirect-on-error print destination. In fact, of all the displayed printer drivers, drivers usable as the redirect-on-error print destination are limited by the print job.

In addition, there is no level setting between perfect compatible print output to an output apparatus such as a sorter or stapler and simple compatible output which allows only output. For this reason, the redirect-on-error print destination cannot efficiently be selected in accordance with a user's request on a case-by-case bases.

### SUMMARY OF THE INVENTION

The present invention has been made to solve the above-described problems and provides a redirect-on-error print system in which when a print error has occurred in a redirect-on-error destination printing apparatus, and a personal computer acquires an error notification, only printer drivers having the same function as that of the printer driver which has output the data to the printing apparatus with the print error are listed up from registered printer drivers, and the user is caused to select a redirect-on-error print destination from them so that any inappropriate print output can reliably be avoided.

The present invention also provides a redirect-on-error print system in which when a print error has occurred in a redirect-on-error destination printing apparatus, and a personal computer acquires an error notification, the type of the job (whether the job is respoolable or not) is determined, and if the job is respoolable, all printer drivers which generate a respoolable job are listed up from registered printer drivers, and the user is caused to select a redirect-on-error print destination from them so that any inappropriate print output can reliably be avoided, and flexibility according to the job type can be ensured.

The present invention also provides a redirect-on-error print system in which when a print error has occurred in a redirect-on-error destination printing apparatus, and a personal computer acquires an error notification, only printer drivers having the same function as that of the printer driver which has output the data to the printing apparatus with the print error are listed up from registered printer drivers, only printer drivers capable of implementing perfect compatible print output which also satisfies the output setting of the issued job such as stapling or sorting are further listed up, and the user is caused to select a redirect-on-error print destination from them so that the output method set in the job can also completely be implemented even in redirect-on-error printing.

The present invention also provides a redirect-on-error print system in which when a print error has occurred in a redirect-on-error destination printing apparatus, the user can select, on a personal computer, the compatible level (e.g., output setting perfect compatible or output result compatible) of output in redirect-on-error printing described in the first to third aspects so that a candidate list of printer drivers as appropriate redirect-on-error destinations corresponding to the level can be provided.

According to one aspect of the present invention, preferably, a redirect-on-error print system which transmits a print job to one of a plurality of printers connected to a network, and when a print error has occurred in the printer, executes processing to cause another printer to execute redirect-on-error printing of the print job, comprises
error detection means for detecting the error in the printer which is processing the print job;
error notification means for notifying a user of the error;
redirect-on-error printer detection means for detecting, of the plurality of printers connected to the network, a printer driver of a redirect-on-error enable printer which can process the print job in behalf of the printer with the error; and
redirect-on-error destination candidate notification means for notifying the user, as a redirect-on-error destination candidate, of the printer driver detected by the redirect-on-error printer detection means.

According to another aspect of the present invention, preferably, an information processing apparatus in a redirect-on-error print system which transmits a print job to one of a plurality of printers connected to a network, and when a print error has occurred in the printer, executes processing to cause another printer to execute redirect-on-error printing of the print job, comprises
error recognition means for recognizing the error in the printer which is processing the print job;
condition input means for inputting a condition to detect, of the plurality of printers connected to the network, a printer driver of a redirect-on-error enable printer which should process the print job in behalf of the printer with the error;
redirect-on-error printer detection means for selectively detecting the printer driver of the redirect-on-error enable printer in accordance with the condition input by the condition input means;
redirect-on-error destination candidate notification means for notifying a user, as a redirect-on-error destination candidate, of the printer driver detected by the redirect-on-error printer detection means; and
selection means for selecting one redirect-on-error destination from the notified redirect-on-error destination candidates.

According to another and further aspect of the present invention, preferably, a control method of a redirect-on-error print system which transmits a print job to one of a plurality of printers connected to a network, and when a print error has occurred in the printer, executes processing to cause another printer to execute redirect-on-error printing of the print job, comprises
an error detection step of detecting the error in the printer which is processing the print job;
an error notification step of notifying a user of the error;
a redirect-on-error printer detection step of detecting, of the plurality of printers connected to the network, a printer driver of a redirect-on-error enable printer which can process the print job in behalf of the printer with the error; and
a redirect-on-error destination candidate notification step of notifying the user, as a redirect-on-error destination candidate, of the printer driver detected in the redirect-on-error printer detection step.

According to another and further aspect of the present invention, preferably, a control program to control an information processing apparatus in a redirect-on-error print system which transmits a print job to one of a plurality of printers connected to a network, and when a print error has occurred in the printer, executes processing to cause another printer to execute redirect-on-error printing of the print job, comprises
a code for executing an error recognition step of recognizing the error in the printer which is processing the print job;
a code for executing a condition input step of inputting a condition to detect, of the plurality of printers connected to the network, a printer driver of a redirect-on-error enable printer which should process the print job in behalf of the printer with the error;
a code for executing a redirect-on-error printer detection step of selectively detecting the printer driver of the redirect-on-error enable printer in accordance with the condition input in the condition input step;
a code for executing a redirect-on-error destination candidate notification step of notifying a user, as a redirect-on-error destination candidate, of the printer driver detected in the redirect-on-error printer detection step; and
a code for executing a selection step of selecting one redirect-on-error destination from the notified redirect-on-error destination candidates.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the descriptions, serve to explain the principle of the invention.

FIG. 1 is a view showing an arrangement example of a network system to which the present invention is applied;

FIG. 2 is a block diagram showing an arrangement example of a personal computer (PC) to which the present invention is applied;

FIG. 3 is a block diagram of a print job control system to which the present invention is applied;

FIG. 4 is a view for explaining the processing flow of a print job in the print job control system to which the present invention is applied;

FIG. 5 is a view showing an example of a printer driver selection window in manual redirect-on-error processing according to the present invention;

FIG. 6 is a flowchart for explaining an operation of notifying a user of redirect-on-error destination candidates in the first embodiment;

FIG. 7 is an explanatory view of “respooling” according to the present invention;

FIG. 8 is a flowchart for explaining an operation of notifying a user of redirect-on-error destination candidates in the second embodiment;

FIG. 9 is a flowchart for explaining an operation of notifying a user of redirect-on-error destination candidates in the third embodiment;

FIG. 10 is a view showing an example of a display window used in the fourth embodiment of the present invention;

FIG. 11 is a flowchart for explaining an operation of notifying a user of redirect-on-error destination candidates in the fourth embodiment;

FIG. 12 is a view showing another example of the display window used in the fourth embodiment of the present invention;

FIG. 13 is a flowchart showing the operation of the first detailed example used in the description of the fourth embodiment;

FIG. 14 is a flowchart showing the operation of the second detailed example used in the description of the fourth embodiment;

FIG. 15 is a flowchart showing the operation of the third detailed example used in the description of the fourth embodiment; and

FIG. 16 is a view showing an example of the display window on which a default redirect-on-error destination is displayed.

### DETAILED DESCRIPTION OF THE PREFERRED EMBODIMENTS

The best mode for carrying out the present invention will be described below in detail with reference to the accompanying drawings. The overall system arrangement will be described first, and the embodiments will be described. The embodiments are merely examples and should not be used to construe to limit the present invention.

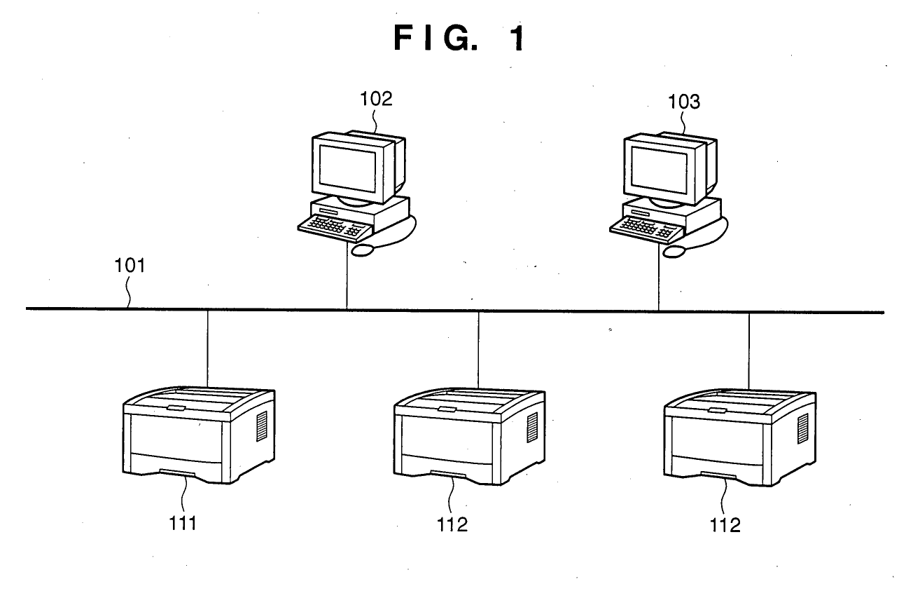

FIG. 1 is a view showing the arrangement of a redirect-on-error print system according to the present invention, which includes printers and personal computers.

Referring to FIG. 1, reference numeral 101 denotes a local area network (LAN). Personal computers 102 and 103 and printers 111, 112, and 113 are connected to the LAN.

The personal computers (PCs) 102 and 103 are arranged as output control apparatuses of this embodiment. The first, second, and third network printers 111, 112, and 113 are arranged as printing apparatuses. These apparatuses are connected through a network line 101.

FIG. 1 illustrates only two PCs 102 and 103. However, the means for executing the procedures of this embodiment may be executed by a plurality of personal computers (PCs) divisionally or in cooperation with each other.

In this embodiment, the network printers 111, 112, and 113 are used. However, the output destination change method is not limited to that described in this embodiment and can be applied independently of the method of connecting the printing apparatuses (network printers) and host computer.

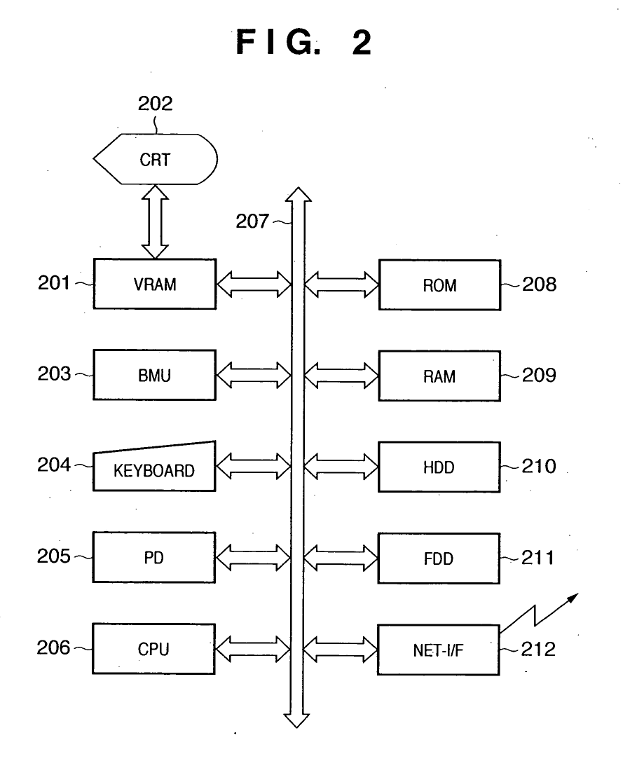

FIG. 2 shows the schematic arrangement of each of the PCs 102 and 103 shown in FIG. 1. Referring to FIG. 2, a video RAM (VRAM) 201 bitmaps and stores characters and images to be displayed on the screen of a CRT display device 202. A bit move unit (BMU) 203 controls data transfer between memories or between a memory and a device. A keyboard 204 comprises various kinds of keys related to input. A pointing device (PD) 205 is used to, e.g., point an icon on the window. A CPU 206 controls the respective units of the apparatus on the basis of a control program stored in a ROM 208 (the ROM 208 also stores programs to implement the present invention (to be described later), including a program according to the present invention and an error processing program). A RAM 209 is used as a work area when the CPU 206 executes the above-described programs or as a temporary save area in error processing. Reference numeral 210 denotes a hard disk drive (HDD); and 211, a floppy disk drive (FDD). The disks are used to store application programs (to be described later), data, and libraries. A network interface (NET-I/F) 212 executes data control and diagnosis on the network to transmit/receive data to/from another device. An I/O bus (including an address bus, data bus, and control bus) 207 which connects the above-described units.

In the above-described arrangement, when the apparatus is powered on, the CPU 206 initializes the apparatus in accordance with the boot program in the ROM 208, loads the OS from the HDD 210, and causes various kinds of applications to run then.

Since the apparatus of this embodiment is based on a general-purpose information processing apparatus (personal computer), the programs are stored in the hard disk. However, they may be stored in a ROM. The present invention is not limited by the storage medium.

(Processing of Print Job)

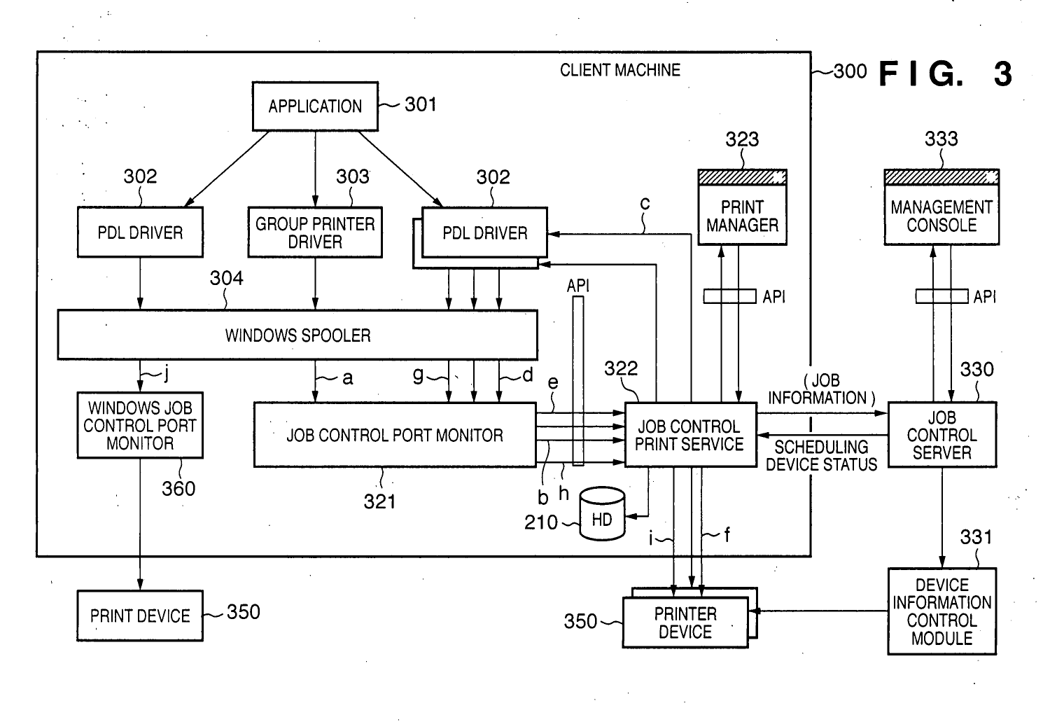

FIG. 3 is a block diagram showing processing of a print job issued by an application. FIG. 3 illustrates how to cause the print job control system to process a print job issued by a general application such as MicroSoftWord (registered trademark) in the client/server model of this system.

Referring to FIG. 3, a server 300 (corresponding to the server 101) is a machine in which the modules of the print job control system operate.

Normally, a print instruction is input, an application program 301 causes the graphic function of the OS to generate a series of rendering instructions. The rendering instructions are transferred to a Windows (registered trademark) spooler 303 through a printer driver. The Windows (registered trademark) spooler 303 executes procedures of transferring print job data to a port monitor selected by the user and causing the port monitor to transmit the print job data to a printer device.

In this embodiment, the user designates in advance a port monitor (to be referred to as a job control port monitor hereinafter) 304 for the print job control system and instructs printing. The application program 301 generates a rendering instruction through a series of OSs.

Upon receiving the rendering instruction, a PDL printer driver 302 generates print data and transmits the print job data not to a port monitor which transmits it to a printer device but to the job control port monitor 304. Instead of transmitting the print job data to a printer device 307, the job control port monitor 304 transmits it to a print service (to be referred to as a job control print service hereinafter) 305 for the print job control system. The job control print service 305 (the error detection means of the information processing apparatus) has a function of managing the states of the job and device.

When devices and client PCs operate mutually in a peer-to-peer environment, the job control print service 305 also has a function of managing information such as a device state or job state notified by a device or outputting a predetermined instruction to the device. This corresponds to a function of managing the device information or job information of a plurality of printer devices 307.

A print manager (to be referred to as a job control print manager hereinafter) 309 for the print job control system is a program which provides a user interface (UI) to allow the user to check the state of the print job in the job control print service 305 or manipulate the print job.

The job control print manager 309 (an error recognition means of the present invention) has a function of transmitting/receiving information to/from the job control print service 305 through the interface (API) of its software to mainly acquire, as an event, the status information of an external printer device managed by the job control print service 305. It is assumed that examples of event notifications are error/warning information notifications such as toner level warning, communication error between the client and device, memory shortage, and full load on the paper output tray, and normal information notifications such as return from an error state to a normal state.

The job control print service 305 has a function of monitoring statuses such as the power control state and error information (paper jam) during printing execution by each device (printing apparatus) communicable through the network.

A management console 310 (to be referred to as a job control management console hereinafter) for the print job control system can monitor the whole print job control system by transmitting/receiving information and instructions to/from the job control print service 305 via an API for access by software installed in the job control print service 305.

The job control print service 305 also communicates with each printer device 307 by using a device information control module 306 and acquires or manipulates information about a print job in a printer or its operation state.

(Print Operation from Print Application 301) Printing from the print application 301 of this embodiment will be described next.

The PDL printer driver 302 converts a series of rendering commands generated by the print application 301 into a PDL file which can be interpreted by a printer device 350.

The PDL file is guided from the Windows (registered trademark) spooler 303 to a job control print service 322 (b in FIG. 3) through the job control port monitor 304 (a in FIG. 3), as described above.

The job control print service 322 controls the operation of the print job in accordance with the type of job control to be executed for the print job.

Referring to FIG. 3, when the job control print service 322 executes load distributed print control, a print job is transmitted to the transmittable printer device 350. A print job is transmitted to a printer device which has become transmittable at an earlier timing. When a plurality of print jobs are generated, they are transmitted to a plurality of transmittable printer devices. This example is indicated by two arrows c and d.

In the general Windows (registered trademark) print system, the PDL printer driver 302 converts a series of rendering commands generated by the application program 301 into a PDL file which can be interpreted by the printer device 350. The PDL file is transferred from the Windows (registered trademark) spooler 303 to the printer device 350 (f in FIG. 3) through a Windows job control port monitor 308 (e in FIG. 3), as described above.

(Relationship Between Windows (Registered Trademark) Print System and Print Job)

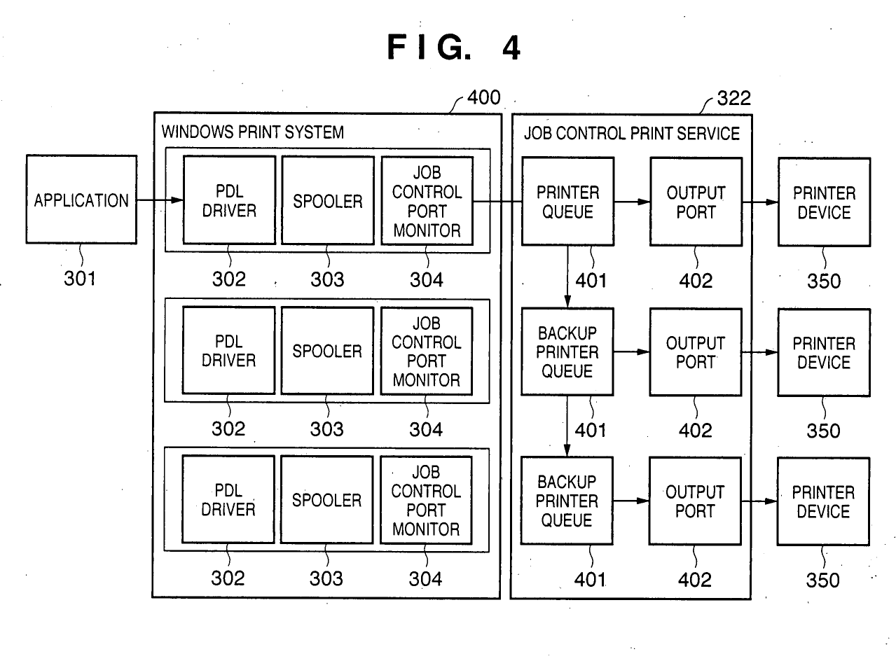

The relationship between a print system provided by Windows (registered trademark) and a print job in the print job control system and the outline of processing will be described next in detail with reference to FIG. 4.

Referring to FIG. 4, the job control print service 322 indicates a print job control system in which the control program of the server 101 runs.

In this embodiment, actual print job data is held by the job control print service 322. The job control print service 322 transmits the print job data to the printer device 350 corresponding to the PDL driver 302 selected by the application.

Processing for causing the job control print service 322 to execute value-added load distributed printing will be described.

When the job control print service 322 executes value-added load distributed printing, the user or application 301 must issue a print job to a printer having setting of load distributed printing, as described above.

The job control print service 322 receives the job data processed by the PDL driver 302 as a PDL file through the job control port monitor 304.

The job control print service 322 receives the job and temporarily holds the job data in a printer queue 401 of its own. The print job is distributed to a printer device corresponding to the printer queue or a backup printer queue 401A or 401B and then transmitted to the printer device 350.

In the present invention, in the print system, when a print error (error) has occurred in a printing apparatus to which an issued job is transmitted, redirect-on-error processing is executed. Especially, when a predetermined error (e.g., paper jam or paper out) has occurred, the print system controls to execute manual redirect-on-error processing. More specifically, candidate printers capable of executing redirect-on-error processing are displayed, and the user designates one of them as a redirect-on-error destination. The following embodiments are based on this arrangement.

### First Embodiment

A redirect-on-error print system according to the first embodiment will be described next. In the first embodiment, when a print error has occurred in a printing apparatus to which an issued job is transmitted, and a redirect-on-error print destination is to be designated, only printer drivers which can execute redirect-on-error printing because they use the same driver engine as that of the issued job are displayed.

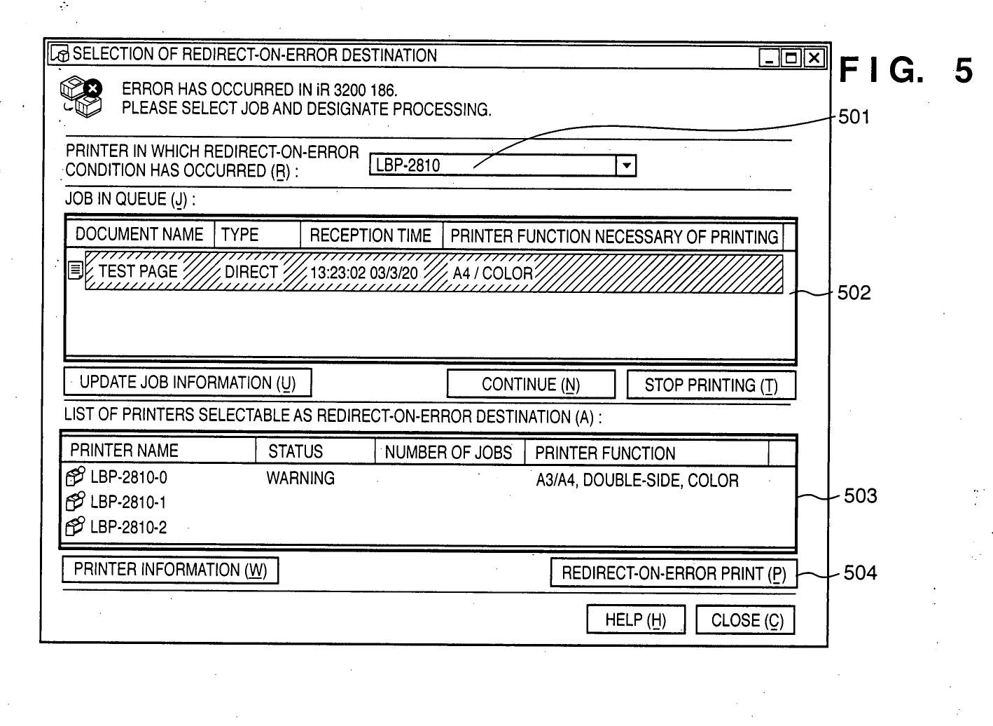

FIG. 5 shows an example of a printer driver selection window in manual redirect-on-error processing. FIG. 5 shows a window displayed on a PC which has received an error notification when an error has occurred in a printing apparatus to which a print job is issued. Referring to FIG. 5, reference numeral 501 denotes a printer driver which sets the printing apparatus with the print error as an output destination. In this case, “LBP-2810” is the printer. A control 502 in FIG. 5 displays a list of jobs whose printing is stopped due to the error. In this example, one job having a document name “test page” is present.

A control 503 displays, as selection items, printer drivers having print engines which can output the print Job displayed by the control 502 in a compatible manner to the “LBP-2810” indicated by the printer driver 501. Actually, there are other registered printer drivers except LBP-2810 with the error and the three printer drivers displayed in the control 503. However, only the three printer drivers displayed in the control 503, which have the same engines as that of LBP-2810, are displayed. When a printer information change button is clicked on, the displayed state is updated. The latest state is displayed in the control 503.

A button 504 instructs the printer driver designated in the control 503 to execute redirect-on-error printing. When this button is clicked on, actual redirect-on-error print processing is started.

This window is merely an example and does not limit the present invention. For example, the control 503 may be a combo-box type. Display of the information in the PDL driver 302 may be unnecessary.

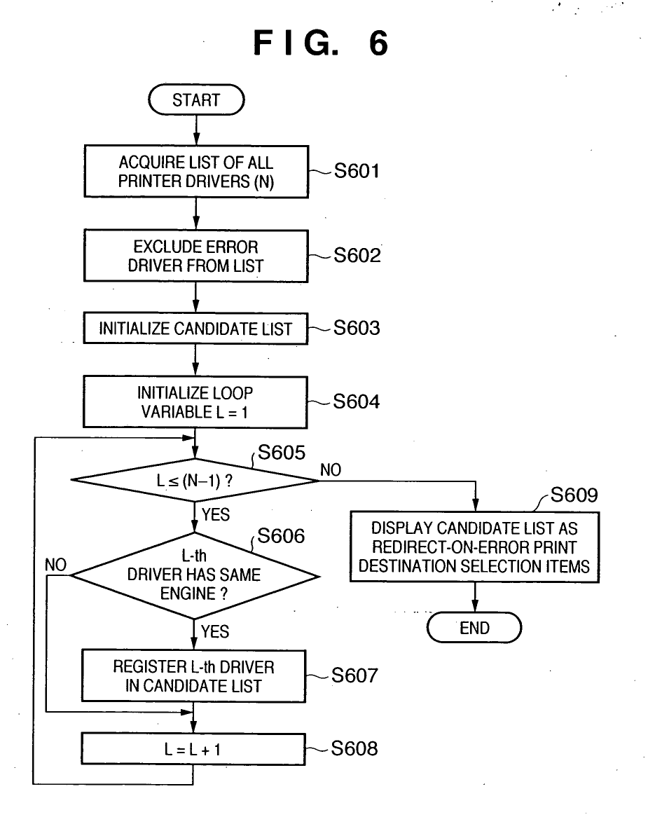

The operation of the redirect-on-error print system according to the first embodiment will be described below with reference to the flowchart shown in FIG. 6.

This flowchart indicates the logic from the time when a print error has occurred in the printing apparatus at the output destination to the time when the PC which has issued the job recognizes the error and displays printer drivers having the same print engine as that of the printing apparatus as redirect-on-error print destination candidates (parts such as acquisition of an actual error notification and redirect-on-error print processing will not be referred to in the present invention and can be known techniques so that they are-not particularly limited).

Referring to FIG. 6, first, in step S601, the list of all printer drivers currently registered in the PC is acquired. Let N be the total number of printer drivers. Throughout the present invention, the acquired value may be held in the memory or saved in a file or the like, and the acquisition source is not particularly limited.

In step S602, the printing apparatus with the error is excluded from the printer driver list acquired in step S601 because it is excluded from the redirect-on-error print destinations. The list of remaining printer drivers includes (N−1) printer drivers.

In step S603, the candidate list which holds information to be displayed as candidates of the redirect-on-error printing apparatus in this embodiment is initialized. In step S604, a variable L to execute loop processing for the (N−1) printer drivers in the list from which the error printer driver is excluded in step S602 is initialized to 1.

In step S605, it is determined whether loop processing with the loop variable L is executed for all the (N−1) printer drivers in the list except the error printing apparatus. If the loop variable L is equal to or smaller than N−1, the flow advances to step S606 to continue loop. If the loop variable L is larger than N−1, it is determined that comparison processing for all the printer drivers is ended, and the flow advances to step S609.

In step S606, it is determined whether the Lth printer driver corresponding to the loop variable L in the printer driver list except the error printing apparatus has the same print engine as that of the printer driver requesting redirect-on-error printing due to the print error.

The “same print engine” may be a print engine capable of creating a PDL file with which the same output result can be obtained from a print document by a printing apparatus by using a printer driver. Hence, the PDL file data itself created by the printer driver may be either the same or not and is not particularly limited. To the contrary, a print engine is regarded as “different” when a PDL file created by one printer driver is transmitted to the output destination of another printer driver, and printing is not possible at all, or a different print result is obtained. That is, even when a print engine creates a PDL file of different data, it is not regarded as “different” as long as the same output result is obtained by a printing apparatus. For example, each printer may have print engine configuration conditions which determine the print output. The conditions of the error printer are compared with those of the remaining printers. If the conditions coincide, the print engines may be regarded as “same” and extracted. Setting can be done such that print engines for which not all conditions coincide may be extracted. Alternatively print engines for which a predetermined number of conditions (set by the user) coincide may be selected.

If YES in step S606, the flow advances to step S607 to update the candidate list. If NO in step S606, the flow advances to step S608. In step S607, the Lth printer driver is registered in the redirect-on-error print destination candidate list because it is determined as the same print engine in step S606. Then, the flow advances to step S608. In step S608, the processing for the Lth printer driver is ended. To execute processing for the (L+1)th printer driver, the loop variable L is incremented by one, and the flow returns to step S605.

If L>(N−1) in step S605, comparison between all printer drivers registered in the list and the printer driver with the error is ended. The flow advances to step S609.

In step S609, the redirect-on-error print destination candidate list created by the processing in steps S601 to S608 is displayed as the redirect-on-error print destination selection items in manual redirect-on-error processing.

With the above-described step processing, the redirect-on-error print destination candidate list creation and display processing of the redirect-on-error print system according to the first embodiment are executed.

As described above, according to the first embodiment, in a printing apparatus to which a job is issued, only printer drivers which can execute redirect-on-error printing because an issued job uses the same driver engine can be displayed. Accordingly, designation of an improper redirect-on-error print destination which may output an inappropriate result can be prevented.

### Second Embodiment

A redirect-on-error print system according to the second embodiment will be described next. In the second embodiment, when a print error has occurred in a printing apparatus to which an issued job is transmitted, and a redirect-on-error print destination is to be designated, the type of the issued job (whether the job is respoolable or not) is determined. If the job is a respoolable job, all respoolable printer drivers are displayed as redirect-on-error print destination candidates.

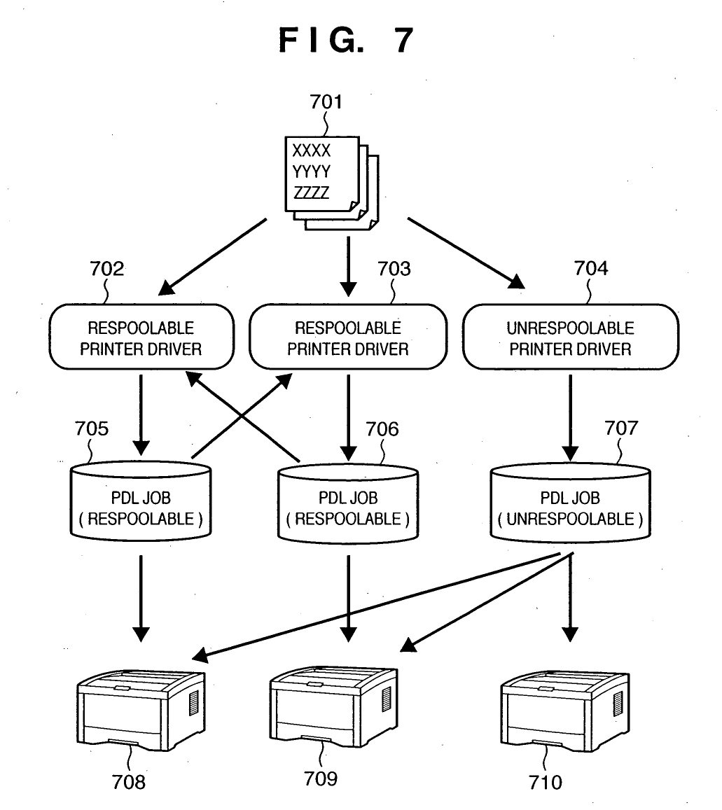

The different points between the first embodiment and the second embodiment will be described first with reference to FIG. 7. Referring to FIG. 7, reference numeral 701 denotes electronic document data to issue a print job. This document data generates, through printer drivers 702, 703, and 704, PDL jobs 705, 706, and 707 to be transmitted to printing apparatuses. The printer drivers 702 and 703 are respoolable printer drivers. The PDL jobs 705 and 705 generated from these printer drivers are respoolable jobs. On the other hand, the printer driver 704 is an unrespoolable printer driver. The PDL job 707 generated from this printer driver is an unrespoolable job. Printing apparatuses 708, 709, and 710 are located as printing apparatuses at output destinations.

For example, when an error has occurred in the printing apparatus 708, and the printer driver 703 is designated as a redirect-on-error print destination, the printer driver 703 analyzes the PDL job 705 and newly generates the PDL job 706. At this time, the printer driver 703 having the function (respooling function) is a respoolable printer driver. The print job output from this printer driver is a respoolable PDL job. In the present invention, however, the respooling method and the PDL job format are not particularly limited if the same layout can be output to another printing apparatus. In the second embodiment, such a printer driver is used.

In the first embodiment, when an error has occurred in the printing apparatus 710 at the output destination, and the PDL job 707 generated by the printer driver 704 having no respooling function considers the printing apparatuses 708 and 709 as redirect-on-error printing apparatuses, it is determined whether the same output result can be obtained.

Hence, in the second embodiment, a printer driver can be selected from wider choices than in the first embodiment.

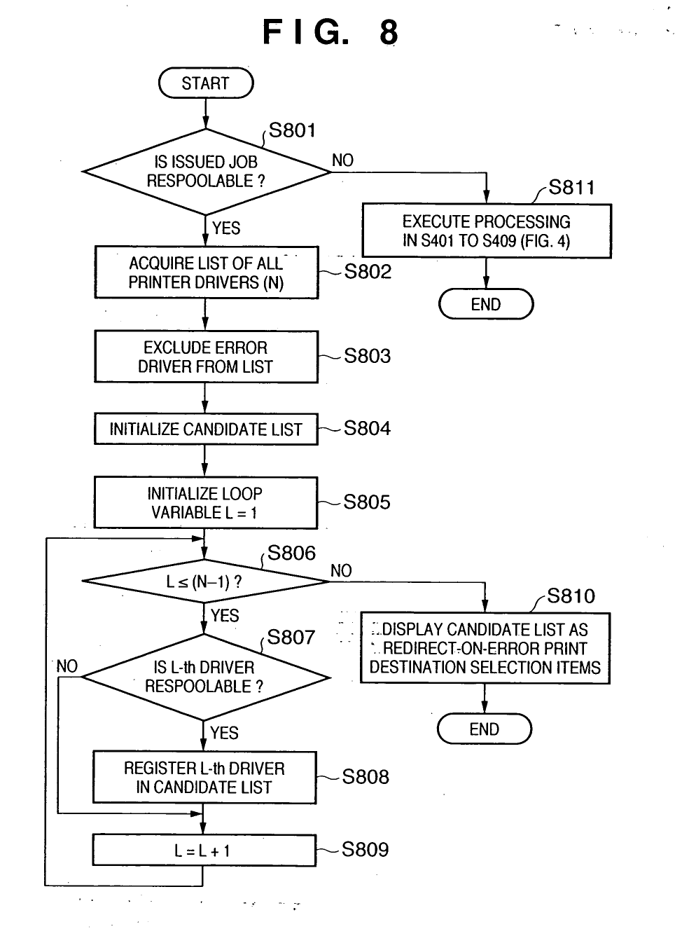

The operation of the redirect-on-error print system according to the second embodiment will be described next with reference to the flowchart shown in FIG. 8.

This flowchart indicates the logic of the processing described in the first embodiment from the time when a print error has occurred in the printing apparatus at the output destination to the time when the PC which has issued the job determines the type of the issued job and selects printer drivers having the same print engine as that of the printing apparatus as redirect-on-error print destination candidates if the job is unrespoolable.

For a respoolable job, the flowchart indicates the logic until all respoolable printer drivers are displayed as redirect-on-error print destination candidates (parts such as acquisition of an actual error notification and redirect-on-error print processing will not be referred to in the present invention and can be known techniques so that they are not particularly limited).

This flow starts when a print job is executed, and an error has occurred in the printing apparatus as the output destination.

Referring to FIG. 8, first, in step S801, it is determined whether the issued job is respoolable. If NO in step S801, the flow advances to step S811 to execute the already described processing in steps S401 to S409 in FIG. 4. Then, the processing is ended.

If YES in step S801, the flow advances to step S802. If the job is respoolable, it can easily be determined that the printer driver which has issued the job is respoolable. It is not particularly determined whether the printer driver itself, which has issued the job, is respoolable. Conversely, when the issue printer driver is a respoolable printer driver, the issued job is automatically a respoolable print job. For this reason, the determination may be done by using the printer driver. The present invention is not particularly limited as long as it can be determined whether the job is respoolable.

In step S802, the list of all printer drivers currently registered in the PC is acquired. Let N be the total number of printer drivers.

In step S803, the printing apparatus with the error is excluded from the printer driver list acquired in step S802 because it is excluded from the redirect-on-error print destinations. The list of remaining printer drivers includes (N−1) printer drivers.

In step S804, the candidate list which holds information to be displayed as candidates of the redirect-on-error printing apparatus in this embodiment is initialized. In step S805, a variable L to execute loop processing for the (N−1) printer drivers in the list from which the error printer driver is excluded in step S803 is initialized to 1.

In step S806, it is determined whether loop processing with the loop variable L is executed for all the (N−1) printer drivers in the list except the error printing apparatus. If the loop variable L is equal to or smaller than N−1, the flow advances to step S807 to continue loop.

If the loop variable L is larger than N−1, it is determined that comparison processing for all the printer drivers is ended, and the flow advances to step S810.

In step S807, it is determined whether the Lth printer driver corresponding to the loop variable L in the printer driver list except the error printing apparatus is a respoolable printer driver.

If YES in step S807, the flow advances to step S808 to add the printer driver to the candidate list. If NO in step S807, the flow advances to step S809. In step S808, the Lth printer driver is registered in the redirect-on-error print destination candidate list because it is determined as a respoolable printer driver in step S807. Then, the flow advances to step S809. In step S809, the processing for the Lth printer driver is ended. To execute processing for the (L+1)th printer driver, the loop variable L is incremented by one, and the flow returns to step S806.

If L>(N−1) in step S806, comparison between all printer drivers registered in the list and the printer driver with the error is ended. The flow advances to step S810.

In step S810, the redirect-on-error print destination candidate list created by the processing in steps S801 to S809 is displayed as the redirect-on-error print destination selection items in manual redirect-on-error processing.

With the above-described step processing, the redirect-on-error print destination candidate list creation and display processing of the redirect-on-error print system according to the second embodiment are executed.

As described above, according to the second embodiment, in a printing apparatus to which a job is issued, if the issued job is respoolable (a job issued from a respoolable printer driver), respoolable printer drivers can be displayed as redirect-on-error print destination candidates. Accordingly, designation of an improper redirect-on-error print destination which may output an inappropriate result can be prevented. In addition, wider candidates can be provided as choices for the redirect-on-error printing apparatus.

### Third Embodiment

A redirect-on-error print system according to the third embodiment will be described next. In the third embodiment, when a print error has occurred in a printing apparatus to which an issued job is transmitted, and a redirect-on-error print destination is to be designated, output setting information (e.g., sorter or staple) of the issued job is acquired. In addition, the output configuration information (e.g., the presence/absence of the sorter function or staple function) of each printing apparatus which can be designated as a redirect-on-error print destination is acquired. On the basis of the acquired output configuration information of printing apparatuses, a printer driver having, as the output destination, a printing apparatus which satisfies the output setting conditions of the issued job is displayed as a redirect-on-error print destination candidate.

The output setting of the issued job is not particularly limited if it is information about the output form such as the paper size, staple function, or staple position.

The output configuration information of the printer device is not particularly limited, either, and can be dynamic information such as the sorter function, staple function, outputtable paper size, or current remaining amount of paper. However, the output configuration information cannot be warning or the state of the printer device itself such as an error.

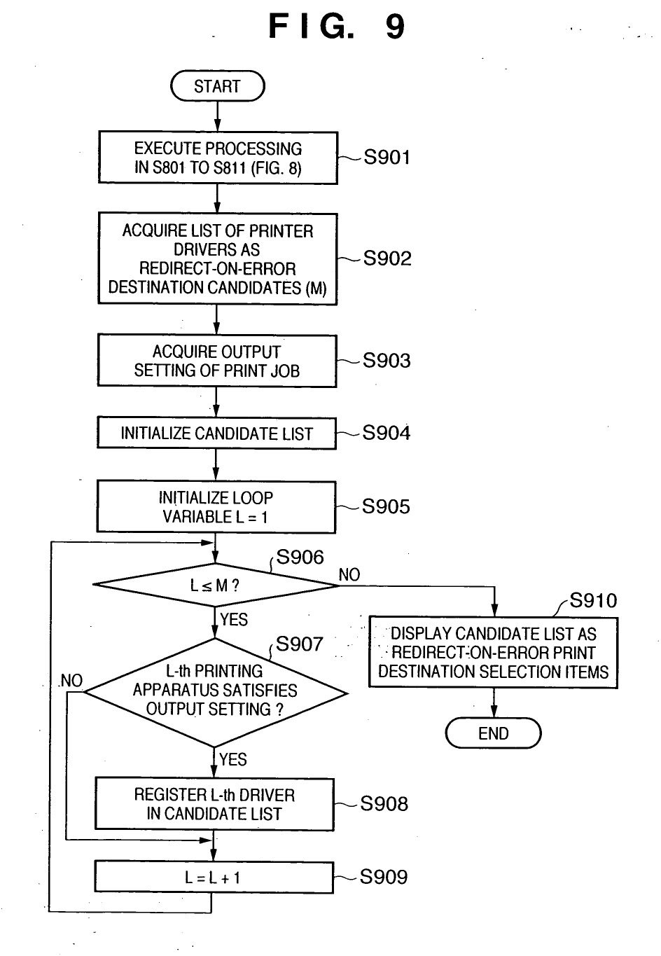

FIG. 9 is a flowchart for explaining the operation of the redirect-on-error print system according to the third embodiment. In this flowchart, after filtering based on the type of a print job is executed in accordance with the flow shown in FIG. 8 (including FIG. 6), re-filtering of information about output setting is executed, for the descriptive convenience. Instead, the loop processing indicated by the flow shown in FIG. 9 may be executed in the loop processing indicated by the flow shown in FIG. 8.

This flowchart indicates the logic from the time when a print error has occurred in the printing apparatus at the output destination to the time when the PC which has issued the job executes printer driver filtering processing shown in FIG. 8, acquires output configuration information of printing apparatuses at the output destinations of the printer drivers as the redirect-on-error print destination candidates, and filters printer drivers which satisfy the output setting information of the currently suspended print job.

Referring to FIG. 9, step S901 is filtering processing of printer drivers as redirect-on-error print destinations on the basis of the type of the print job shown in FIG. 8. With this processing, a candidate list obtained by filtering printer drivers capable of outputting the currently suspended print job as a printed product is present.

In step S902, the candidate list of printer drivers as redirect-on-error print destinations listed up in step S901 is acquired. Let M be the number of printer drivers in the candidate list.

In step S903, the output setting of the print job to be subjected to redirect-on-error printing is acquired. The output setting changes depending on the print job. When a plurality of jobs are present, output setting is acquired for each job. The subsequent processing must be executed for each job.

In step S904, the candidate list to store final printer driver candidates of the redirect-on-error print destination, which is implemented in the third embodiment, is initialized.

In step S905, a variable L to execute loop processing for the M printer drivers in the candidate list which is acquired in step S902 and includes the candidates selected in step S901 is initialized to 1.

In step S906, it is determined whether loop processing with the loop variable L is executed for all the M printer drivers in the candidate list acquired in step S902. If the loop variable L is equal to or smaller than M, the flow advances to step S907 to continue loop. If the loop variable L is larger than M, it is determined that comparison processing for all the printer drivers is ended, and the flow advances to step S910.

In step S907, the output configuration information of a printing apparatus as an output destination is acquired from the Lth printer driver corresponding to the loop variable L and compared with output setting which satisfies the output setting of the print job acquired in step S903. If the output configuration information of the printing apparatus satisfies the output setting, the flow advances to step S908 to add the printer driver to the final candidate list of printer drivers as redirect-on-error print destinations. If the output configuration information does not satisfy the output setting, the flow advances to step S909.

In step S908, the Lth printer driver is registered in the final redirect-on-error print destination candidate list because it is determined in step S907 as a printer driver having a printing apparatus which satisfies the output setting of the print job. Then, the flow advances to step S909. In step S909, the processing for the Lth printer driver is ended. To execute processing for the (L+1)th printer driver, the loop variable L is incremented by one, and the flow returns to step S906.

If L>M in step S906, for the printer drivers in the candidate list acquired in step S902, comparison between the output configuration information of each printing apparatus as an output destination and the output setting information of the print job is ended. The flow advances to step S910.

In step S910, the final redirect-on-error print destination candidate list created by the processing in steps S901 to S909 is displayed as the redirect-on-error print destination selection items in manual redirect-on-error processing.

With the above-described step processing, the redirect-on-error print destination candidate list creation and display processing of the redirect-on-error print system according to the third embodiment are executed.

As described above, according to the third embodiment, in a printing apparatus to which a job is issued, the printer driver candidate list of redirect-on-error print destinations can be created as in the first and second embodiments. In addition, printer drivers which can also implement the output setting of the print job can be presented as the final candidate list. Especially, even when the output method such as stapling or sorting is important, redirect-on-error print destination selection candidates which satisfy redirect-on-error print processing desired by the user can be provided.

### Fourth Embodiment

A redirect-on-error print system according to the fourth embodiment will be described next.

In the fourth embodiment, the user can select the method of generating a redirect-on-error print destination candidate list to be displayed when a redirect-on-error print destination is to be designated from the methods of the above-described first to third embodiments. The candidate list generation method selectable here is not limited to the methods of the first to third embodiments and can be any other candidate classification method convenient for the user to use.

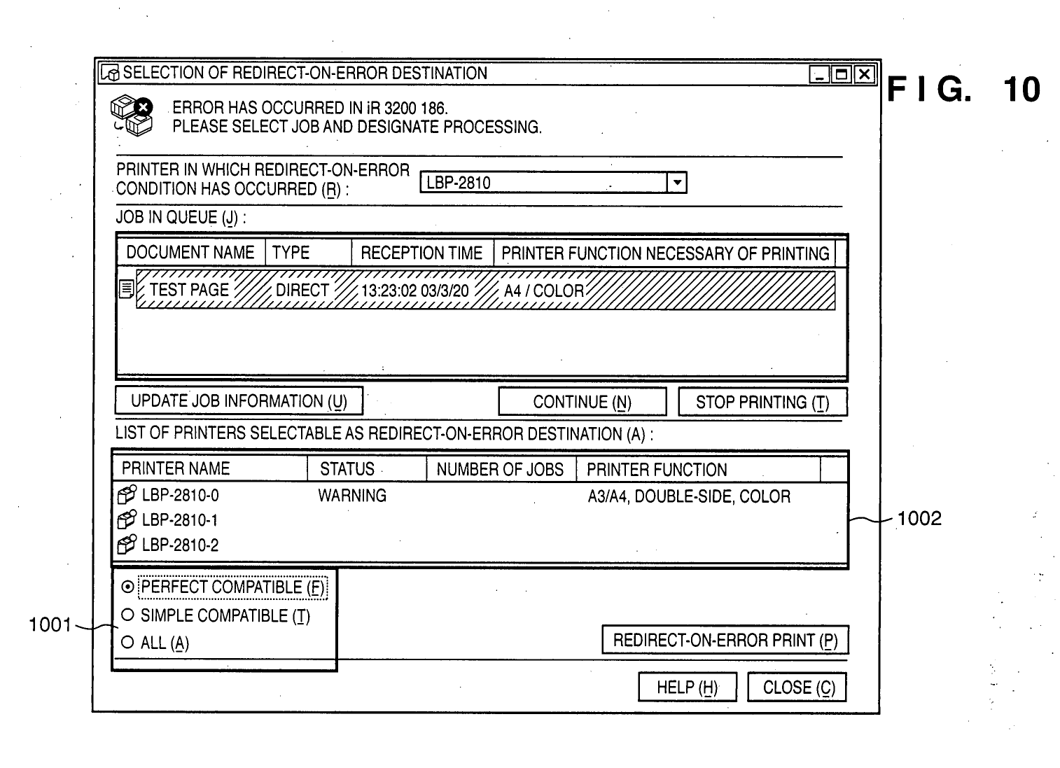

FIG. 10 shows an example of display of a window according to the fourth embodiment. Referring to FIG. 10, reference numeral 1001 denotes a condition input means and, more specifically, a radio control which causes the user to select the method of generating the candidate list of printer drivers as redirect-on-error print destinations. FIG. 10 illustrates “perfect compatible”, “simple compatible”, and “all”. For example, “perfect compatible” is processing for generating a candidate list of printer drivers as redirect-on-error print destinations which can implement redirect-on-error printing including output setting. “Simple compatible” is processing for generating a candidate list of printer drivers which implement the same contents in each page of the printed product without considering output setting. “All” is a method of displaying all registered printer drivers. In this processing, no filtering is executed.

When the user selects one of the three selection items in accordance with the situation in redirect-on-error printing, a printer driver candidate list corresponding to the selection method is generated.

A list control 1002 displays a candidate list created in accordance with the user selection method.

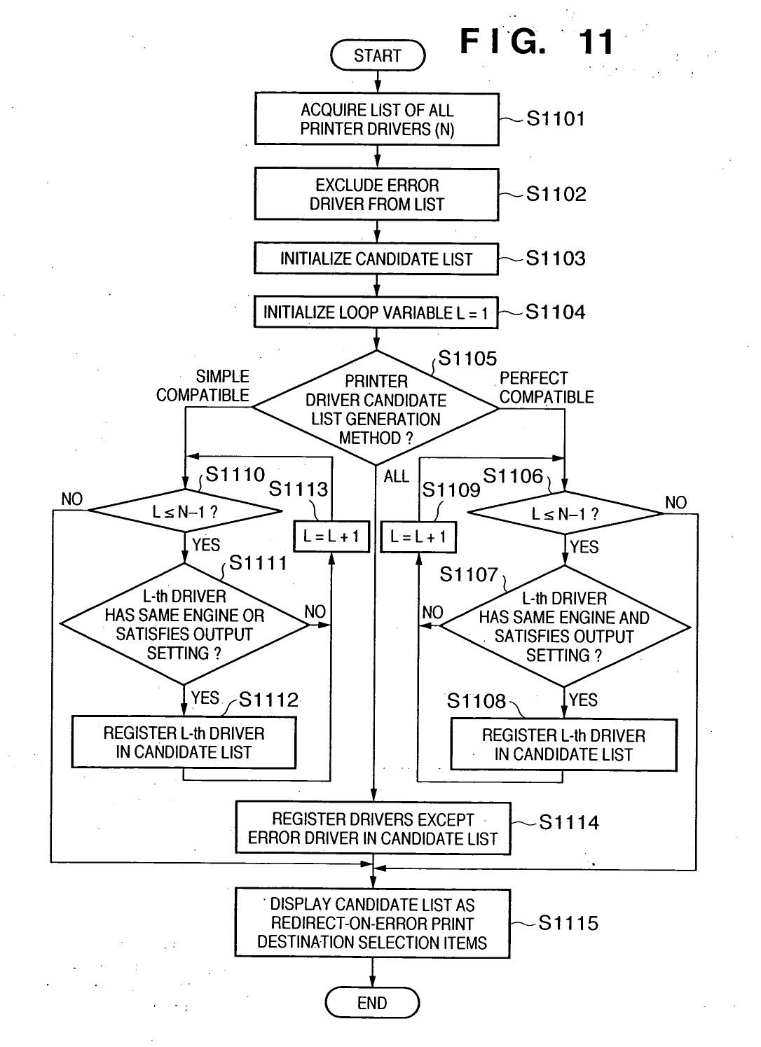

FIG. 11 is a flowchart for explaining the operation of the fourth embodiment. In this flowchart, a candidate list is created in accordance with a candidate list creation method selected by the radio button 1001 in FIG. 10 and displayed in the list control 1002.

Referring to FIG. 11, first, in step S1101, the list of all printer drivers currently registered in the PC is acquired. Let N be the total number of printer drivers. Throughout the present invention, the acquired value may be held in the memory or saved in a file or the like, and the acquisition source is not particularly limited.

In step S1102, the printing apparatus with the error is excluded from the printer driver list acquired in step S1101 because it is excluded from the redirect-on-error print destinations. The list of remaining printer drivers includes (N−1) printer drivers.

In step S1103, the candidate list which holds information to be displayed as candidates of the redirect-on-error printing apparatus in this embodiment is initialized. In step S1104, a variable L to execute loop processing for the (N−1) printer drivers in the list from which the error printer driver is excluded in step S1102 is initialized to 1.

In step S1105, the user designates the method of generating the printer driver candidate list.

If the user designates “perfect compatible”, the processing advances to step S1106. In step S1106, it is determined whether loop processing with the loop variable L is executed for all the (N−1) printer drivers in the list except the error printing apparatus. If the loop variable L is equal to or smaller than N−1, the flow advances to step S1107 to continue loop. If the loop variable L is larger than N−1, it is determined that comparison processing for all the printer drivers is ended, and the flow advances to step S1115.

In step S1107, it is determined whether the Lth printer driver corresponding to the loop variable L in the printer driver list except the error printing apparatus has the same print engine as that of the printer driver requesting redirect-on-error printing due to the print error and satisfies the output setting (the same as in step S907 in FIG. 9).

The “same print engine” may be a print engine capable of creating a PDL file with which the same output result can be obtained from a print document by a printing apparatus by using a printer driver. Hence, the PDL file data itself created by the printer driver may be either the same or not and is not particularly limited. To the contrary, a print engine is regarded as “different” when a PDL file created by one printer driver is transmitted to the output destination of another printer driver, and printing is not possible at all, or a different print result is obtained. That is, even when a print engine creates a PDL file of different data, it is not regarded as “different” as long as the same output result is obtained by a printing apparatus. For example, each printer may have print engine configuration conditions which determine the print output. The conditions of the error printer are compared with those of the remaining printers. If the conditions coincide, the print engines may be regarded as “same” and extracted. Setting can be done such that print engines for which not all conditions coincide may be extracted. Alternatively, print engines for which a predetermined number of conditions (set by the user) coincide may be selected.

If YES in step S1107, the flow advances to step S1108 to update the candidate list.

If the print engine is different, or the output setting is not satisfied, the processing advances to step S1109.

In step S1108, the Lth printer driver is registered in the redirect-on-error print destination candidate list because it is determined in step S1107 that the print engine is the same, and the output setting is satisfied. Then, the flow advances to step S1109. In step S1109, the processing for the Lth printer driver is ended. To execute processing for the (L+1)th printer driver, the loop variable L is incremented by one, and the flow returns to step S1106.

If L>(N−1) in step S1106, comparison between all printer drivers registered in the list and the printer driver with the error is ended. The flow advances to step S1115.

If the user designates “simple compatible” in step S1105, the processing advances to step S1110. In step S1110, it is determined whether loop processing with the loop variable L is executed for all the (N−1) printer drivers in the list except the error printing apparatus. If the loop variable L is equal to or smaller than N−1, the flow advances to step S1111 to continue loop. If the loop variable L is larger than N−1, it is determined that comparison processing for all the printer drivers is ended, and the flow advances to step S1115.

In step S1111, it is determined whether the Lth printer driver corresponding to the loop variable L in the printer driver list except the error printing apparatus has the same print engine as that of the printer driver requesting redirect-on-error printing due to the print error or satisfies the output setting. The “same print engine” can be defined in the same way as described above.

If YES in step S1111, the flow advances to step S1112 to update the candidate list.

If the print engine is different, or the output setting is not satisfied, the processing advances to step S1113.

In step S1112, the Lth printer driver is registered in the redirect-on-error print destination candidate list because it is determined in step S111 that the print engine is the same, or the output setting is satisfied. Then, the flow advances to step S1113. In step S1113, the processing for the Lth printer driver is ended. To execute processing for the (L+1)th printer driver, the loop variable L is incremented by one, and the flow returns to step S1110.

If L>(N−1) in step S1110, comparison between all printer drivers registered in the list and the printer driver with the error is ended. The flow advances to step S1115.

If the user designates “all” in step S1105, the processing advances to step S1114. In step S1114, all printer drivers except the printer driver with the error are registered in the candidate list.

With the above-described processing, finally in step S1115, the redirect-on-error print destination candidate list created by the processing in steps S1101 to S1114 is displayed as the redirect-on-error print destination selection items in manual redirect-on-error processing.

With the above-described step processing, the redirect-on-error print destination candidate list creation and display processing of the redirect-on-error print system according to the fourth embodiment are executed.

As described above, according to the fourth embodiment, the redirect-on-error print destination display form can be changed in accordance with user selection. Hence, display can be done in accordance with the print environment or user's taste, resulting in large convenience.

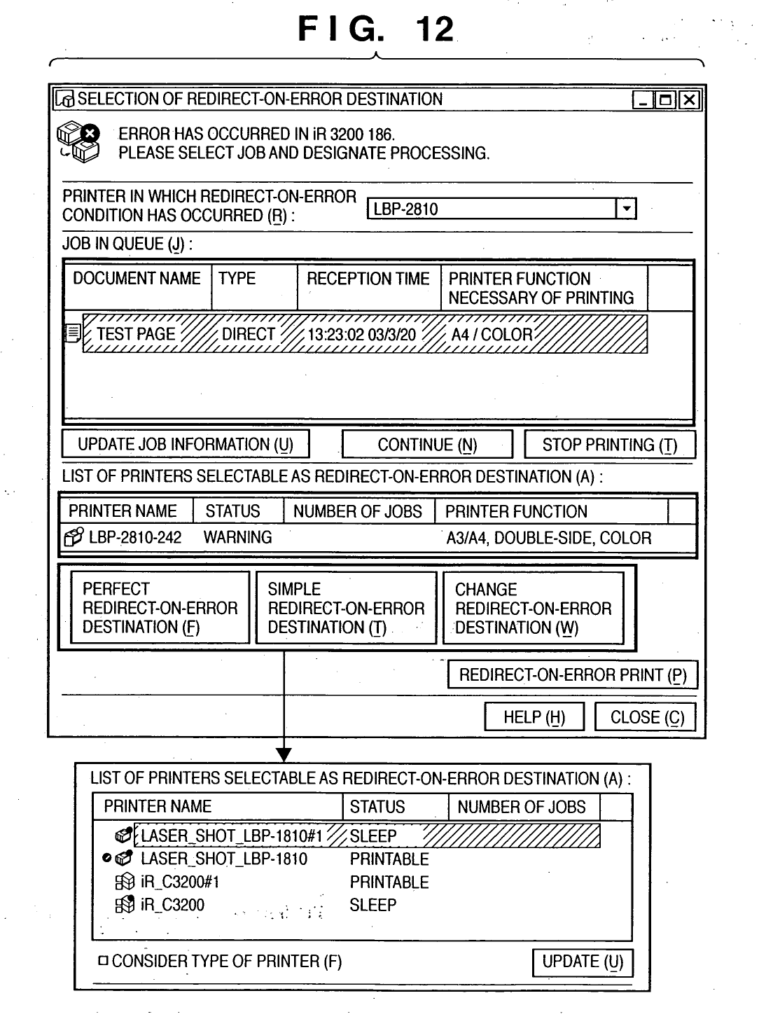

Referring to FIG. 10, the user selects display by using the radio button. Instead, a redirect-on-error destination selection dialogue may be displayed, as shown in FIG. 12, in which candidate printers are displayed on the basis of the log. At this time, the redirect-on-error destination change operation is done by displaying candidate printers by selecting “perfect compatible”, “simple compatible”, or “all”, as shown in FIG. 11. In displaying the candidate printers, filtering may be executed by using a log related to redirect-on-error processing, as will be described next.

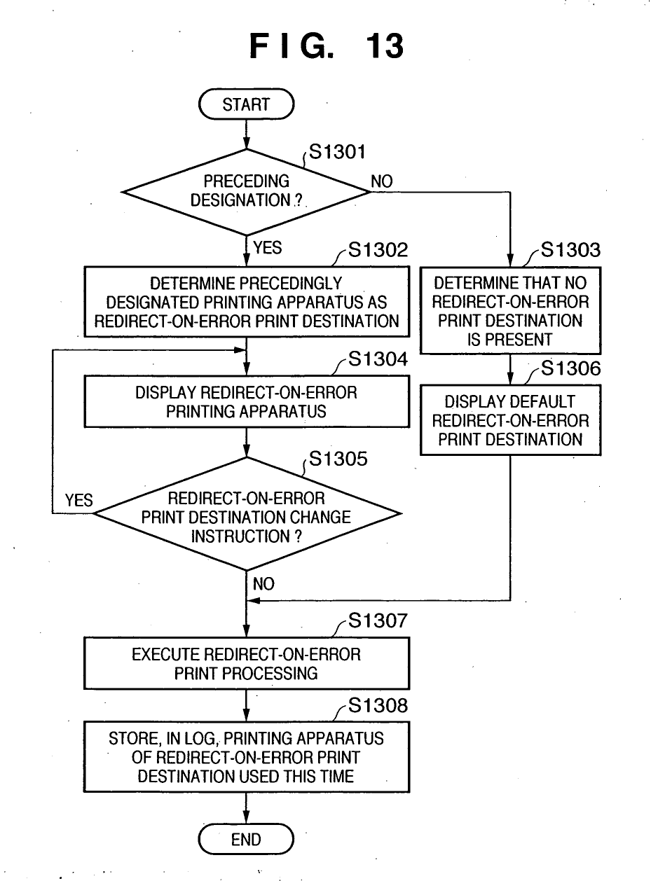

FIGS. 13 to 15 are flowcharts for explaining methods of displaying a candidate printer by using a redirect-on-error log.

### FIRST DETAILED EXAMPLE

FIG. 13 is a flowchart showing the operation of the first detailed example of the method of displaying a candidate printer by using a redirect-on-error log.

This flowchart indicates the logic from the time when a print error has occurred in the printing apparatus at the output destination to the time when the PC which has issued the job recognizes the error, displays a printing apparatus used in preceding redirect-on-error printing as a redirect-on-error print destination, and stores it as redirect-on-error print destination log information when the user inputs a print instruction. Actually, redirect-on-error print processing is located after this flow (parts such as error notification acquisition as the initial processing of this flow and redirect-on-error print processing after this flow will not be referred to in the present invention and can be known techniques so that they are not limited and will not be described particularly).

Referring to FIG. 13, first, in step S1301, it is determined whether a redirect-on-error print log which indicates that redirect-on-error printing has been executed in the past is present in the printing apparatus in which the print error has occurred. If YES in step S1301, the flow advances to step S1302. If NO in step S1301, the processing advances to step S1303 to determine that no redirect-on-error printing has been executed in the past. The method and position of holding the redirect-on-error print log will not particularly be referred to in the present invention.

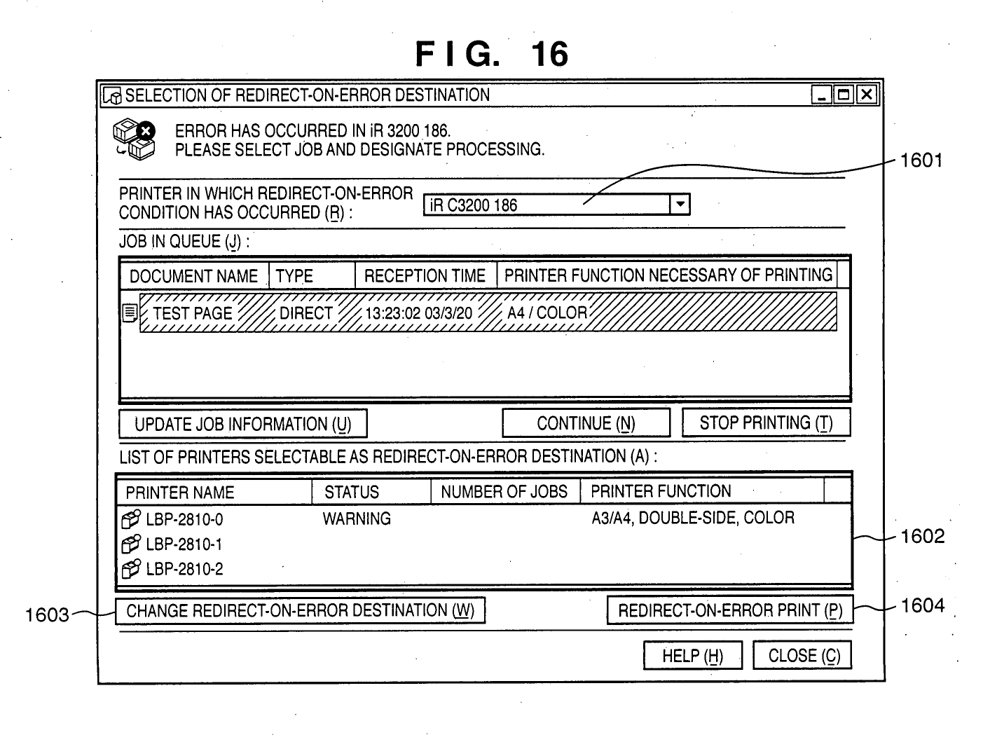

In step S1306, a printing apparatus which is set as a default redirect-on-error printing apparatus candidate is displayed because it is determined that no printing apparatus is recommended as a redirect-on-error print destination for the current processing. For example, the display window shown in FIG. 16 is used.

When the processing advances from step S1301 to S1302, it is determined that a redirect-on-error print log is present. On the basis of the redirect-on-error print destination determination rule of this detailed example, the latest log (preceding value) of the print destination at which the printing apparatus with the current error executes redirect-on-error printing is determined as the printing apparatus for the current redirect-on-error printing.

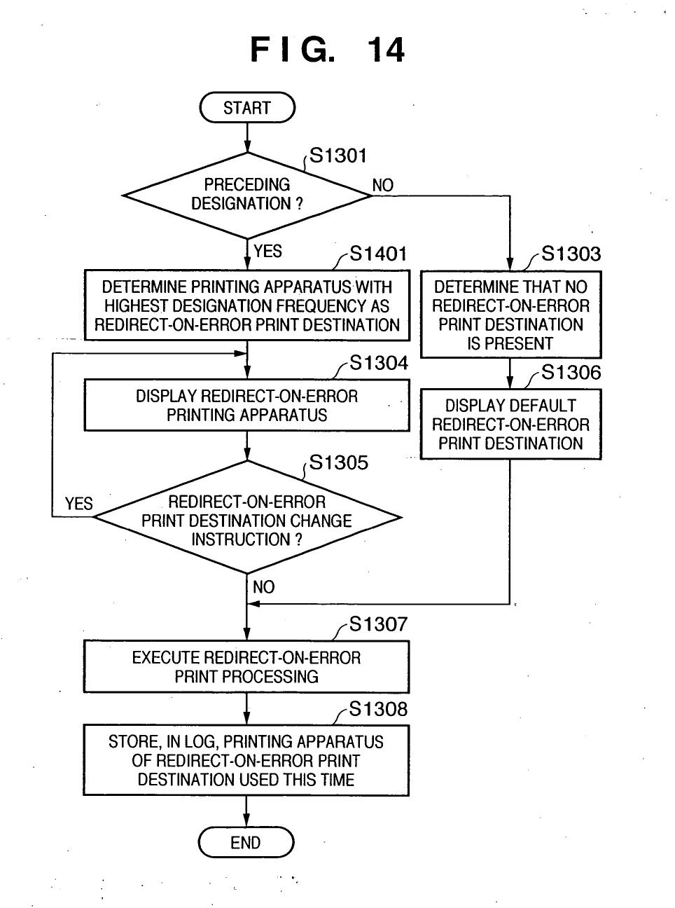

In step S1304, the redirect-on-error printing apparatus determined in step S1302 is displayed on the manual redirect-on-error processing instruction window shown in FIG. 14.

In step S1305, it is determined whether “an instruction to change the redirect-on-error print destination is input” for the printing apparatus displayed (step S1304) as the redirect-on-error printing apparatus on the basis of the determination rule of this embodiment. If YES in step S1305, redirect-on-error print destination change processing is executed. The flow returns to step S1304 to display the changed redirect-on-error printing apparatus. In the present invention, a redirect-on-error printing apparatus is always displayed. If the user wants to change the printing apparatus due to some reason, he/she can freely change it.

If NO in step S1305, i.e., if “redirect-on-error printing” is to be executed, the processing advances to step S1307 to execute redirect-on-error print processing.

The processing advances to step S1308. In accordance with the current series of redirect-on-error print instructions and processing operations, redirect-on-error print information containing at least the printing apparatus with the error, the printing apparatus designated as the redirect-on-error print destination, and the processing date/time is stored as a log. The remaining pieces of information are arbitrary and are not particularly limited. These pieces of information are stored as a criterion for determination in step S1301 later in redirect-on-error print processing.

With the above-described step processing, automatic display processing using the preceding value of the redirect-on-error print destination is executed when a print error has occurred in the first detailed example of the redirect-on-error print system.

As described above, according to the first detailed example, when a print error has occurred in a printing apparatus to which a job is issued, and redirect-on-error printing is to be executed, the printing apparatus used for preceding redirect-on-error printing can automatically displayed. Accordingly, cumbersome processing for causing the user to designate a printing apparatus can be omitted.

### SECOND DETAILED EXAMPLE

The second detailed example of the method of displaying a candidate printer by using a redirect-on-error log will be described next. In the second detailed example, when a print error has occurred in a printing apparatus to which an issued job is transmitted, a printing apparatus suitable for a determination rule using a designation frequency is selected from the past redirect-on-error print destinations of the printing apparatus with the error and displayed as a redirect-on-error printing apparatus in designating a redirect-on-error print destination.

In this detailed example, when redirect-on-error printing is executed by temporarily using a printing apparatus which is different from a usual apparatus in the first detailed example, that temporarily designated printing apparatus can be prevented from becoming the redirect-on-error printing apparatus next time.

In this detailed example, the coefficient of designation frequency is not particularly limited. In addition, the number of logs to be used is not particularly limited, and 100 latest data may be used. In this example, it is important that the determination rule uses the designation frequency.

FIG. 14 is a flowchart for explaining the operation of the second detailed example. This flowchart indicates the logic from the time when a print error has occurred in the printing apparatus at the output destination to the time when the PC which has issued the job recognizes the error, calculates the designation (use) frequency from the redirect-on-error print log, displays a printing apparatus used most frequently as a redirect-on-error print destination, and stores it as redirect-on-error print destination log information when the user inputs a print instruction. Actually, redirect-on-error print processing is located after this flow (as in the first detailed example, parts such as error notification acquisition as the initial processing of this flow and redirect-on-error print processing after this flow will not be referred to in the present invention and can be known techniques so that they are not limited and will not be described particularly).

The operation shown in FIG. 14 starts when a print job is executed, and an error has occurred in the printing apparatus as the output destination.

Referring to FIG. 14, the processing in steps S1301 and S1303 to S1308 described in FIG. 13 is the same as that in FIG. 11, and a description thereof will be omitted. Step S1302 is replaced with step S1401.

In step S1401, the past redirect-on-error print log of the printing apparatus with the current error is acquired. Of the acquired redirect-on-error print log, a printing apparatus having the highest designation frequency is determined as the current redirect-on-error printing apparatus by using an arbitrary designation frequency coefficient. Then, in step S1304, the information is displayed.

With the above-described step processing, a redirect-on-error printing apparatus is determined by using the designation frequency, and automatic display processing is executed when a print error has occurred in the first detailed example.

As described above, according to the second detailed example, when a print error has occurred in a printing apparatus to which a job is issued, redirect-on-error printing is executed. Even when redirect-on-error printing is executed not by using the same redirect-on-error printing apparatus as in the preceding time but by temporarily using a printing apparatus different from the usual apparatus, the temporarily used printing apparatus can be prevented from becoming the redirect-on-error printing apparatus next time. Accordingly, cumbersome processing for causing the user to designate a printing apparatus can be omitted.

### THIRD DETAILED EXAMPLE

The third detailed example of the method of displaying a candidate printer by using a redirect-on-error log will be described next. In the third detailed example, when a redirect-on-error printing apparatus which is determined on the basis of the determination rule based on a redirect-on-error print log described in the first or second detailed example cannot be used due to an error or has already been deleted, the apparatus is excluded from candidates. Then, a redirect-on-error printing apparatus is determined newly by using the determination rule. The error can be, e.g., “paper out”, “toner out”, or “paper jam”. The error is not particularly limited if it is determined that the error makes redirect-on-error print processing impossible. Alternatively, the types of errors may be set. A printing apparatus which is usable in fact but cannot immediately print not due to a simple error but because 100 or more jobs are stacked in a queue may be determined as print disable.

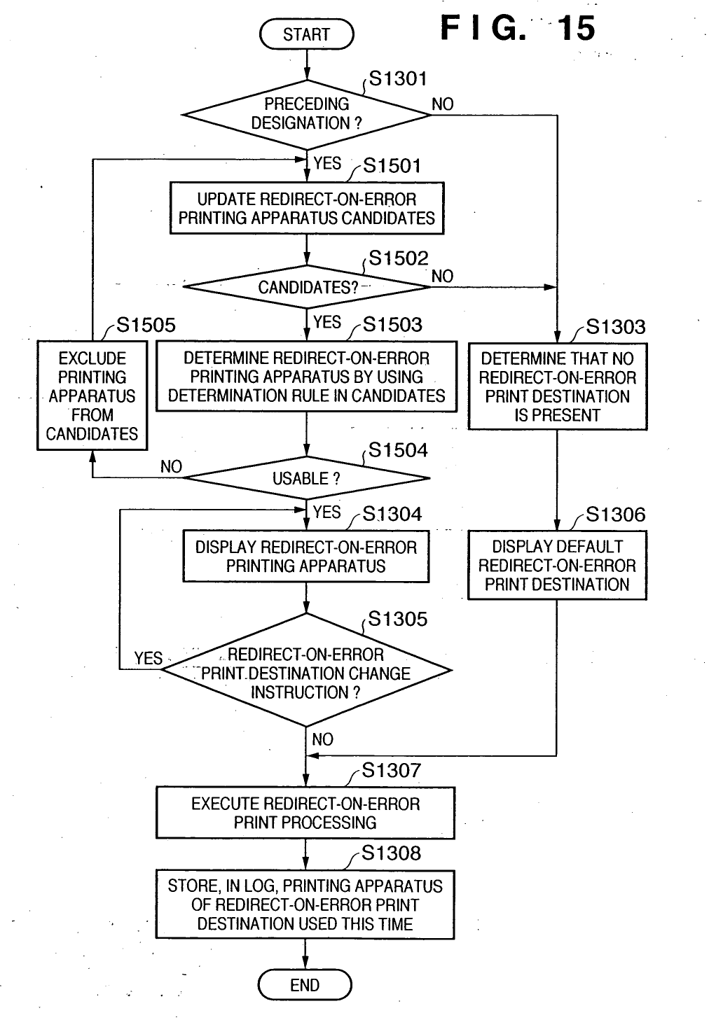

FIG. 15 is a flowchart for explaining the operation of the third detailed example. This flowchart indicates the logic from the time when a print error has occurred in the printing apparatus at the output destination to the time when the PC which has issued the job recognizes the error, determines and displayed a redirect-on-error printing apparatus in accordance with the determination rule, and stores it as redirect-on-error print destination log information when the user inputs a print instruction, like the flowcharts of the first and second detailed examples. As a characteristic feature of the third detailed example, when a print disable apparatus is selected, the printing apparatus is excluded from candidates, and a redirect-on-error printing apparatus is determined again in accordance with the determination rule.

The operation shown in FIG. 15 starts when a print job is executed, and an error has occurred in the printing apparatus as the output destination.

Referring to FIG. 15, the processing in steps S1301 and S1303 to S1308 (except step S1302) described in FIG. 13 is the same as in FIG. 13, and a description thereof will be omitted.

Step S1501 is processing executed when the printing apparatus with the print error has a past redirect-on-error print log in step S1301. Printing apparatuses stored in the redirect-on-error print log are listed up. When the processing returns from step S1505 (to be described later) to step S1501, the list is updated without the currently excluded candidate.

In step S1502, it is determined whether the number of candidates in the list updated in steps 1501 is zero. In the processing of the first time, at least one candidate is present always. Step S1502 is determination processing which is executed in consideration of a case in which there is no candidate because of the loop through step S1505. If no candidate is present, the flow advances to step S1303 to determine that no candidate based on the current redirect-on-error print destination determination rule is to be displayed.

On the other hand, if at least one candidate is present in step S1502, the processing advances to step S1503. In step S1503, a redirect-on-error printing apparatus is determined in accordance with the determination rule described in the first or second detailed example.

In step S1504, the current state of the printing apparatus determined in step S1503 is acquired, and it is determined whether the printing apparatus is usable now. If YES in step. S1504, the flow advances to processing for displaying the printing apparatus determined in step S1503 as a redirect-on-error printing apparatus (a description of the subsequent processing will be omitted).

If NO in step S1504, the processing advances to step S1505.

In step S1505, the redirect-on-error printing apparatus determined in step S1503 is excluded from candidates in the current redirect-on-error print processing because it is determined as unusable. Then, the processing returns to step S1501.

The processing in steps S1501 to S1505 is repeated. When it is determined ins step S1502 that no candidate is present, or it is determined in step S1504 that the determined redirect-on-error printing apparatus is usable, the loop is ended.

With the above-described step processing, the redirect-on-error print destination candidate list creation and display processing according to the third detailed example are executed.

As described above, according to the third detailed example, when a print error has occurred in a printing apparatus to which a job is issued, and redirect-on-error printing is to be executed, it is also guaranteed that the printing apparatus determined as the redirect-on-error printing apparatus is usable, in addition to the processing described in the first and second embodiments. For this reason, desired manual redirect-on-error print processing can be executed without causing the user to intentionally confirm the state of the printing apparatus.

As described above, according to the fourth embodiment, in the printing apparatus to which a job is issued, the method of creating the candidate list of printer drivers as redirect-on-error print destinations can be selected from the methods of the first to third embodiments. Hence, redirect-on-error print destination selection candidates which satisfy user's desired redirect-on-error printing conditions can be provided in accordance with the situation.

According to the redirect-on-error print system of the present invention with the above-described arrangement, in designating a redirect-on-error printing apparatus for redirect-on-error print processing which is executed when a print error has occurred in a printing apparatus connected to the network, any operation of designating a printer driver (printing apparatus) which may produce an inappropriate output result can be prevented. Hence, the redirect-on-error print system can efficiently be operated.

In addition, when printer drivers which satisfy a redirect-on-error print result of user's desired level are provided every time as a redirect-on-error print destination candidate list, the user can easily select an appropriate printer driver of a redirect-on-error print destination in accordance with the situation.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2003-405029 filed Dec. 3, 2003, which is hereby incorporated by reference herein.

1. A redirect-on-error print system which transmits a print job to one of a plurality of printers connected to a network, and when a print error has occurred in the printer, executes processing to cause another printer to execute redirect-on-error printing of the print job, comprising:
error detection means for detecting the error in the printer which is processing the print job;
error notification means for notifying a user of the error;
redirect-on-error printer detection means for detecting, of the plurality of printers connected to the network, a printer driver of a redirect-on-error enable printer which can process the print job in behalf of the printer with the error; and
redirect-on-error destination candidate notification means for notifying the user, as a redirect-on-error destination candidate, of the printer driver detected by said redirect-on-error printer detection means.

2. The system according to claim 1, wherein
the redirect-on-error print system comprises the plurality of printers, an information processing apparatus, and a server,
the information processing apparatus includes at least said error detection means, said error notification means, said redirect-on-error printer detection means, and said redirect-on-error destination candidate notification means, and
communication between the plurality of printers and the information processing apparatus is executed through the server.

3. An information processing apparatus in a redirect-on-error print system which transmits a print job to one of a plurality of printers connected to a network, and when a print error has occurred in the printer, executes processing to cause another printer to execute redirect-on-error printing of the print job, comprising:
error recognition means for recognizing the error in the printer which is processing the print job;
condition input means for inputting a condition to detect, of the plurality of printers connected to the network, a printer driver of a redirect-on-error enable printer which should process the print job in behalf of the printer with the error;
redirect-on-error printer detection means for selectively detecting the printer driver of the redirect-on-error enable printer in accordance with the condition input by said condition input means;
redirect-on-error destination candidate notification means for notifying a user, as a redirect-on-error destination candidate, of the printer driver detected by said redirect-on-error printer detection means; and
selection means for selecting one redirect-on-error destination from the notified redirect-on-error destination candidates.

4. The apparatus according to claim 3, wherein a type of the printer driver includes a first driver type which issues a print job having a format capable of respooling a predetermined document and a second driver type which issues a print job having a format incapable of respooling.

5. The apparatus according to claim 4, wherein when the print job is issued by a printer driver belonging to the first driver type, said redirect-on-error destination candidate notification means notifies the user, as the redirect-on-error destination candidates, of all printer drivers belonging to the first driver type.

6. The apparatus according to claim 4, wherein when the print job is issued by a printer driver belonging to the second driver type, said redirect-on-error destination candidate notification means notifies the user, as the redirect-on-error destination candidates, of only a printer driver using a print engine which can be regarded for a predetermined condition as the same as that of the printer with the error in accordance with the condition input by said condition input means.

7. The apparatus according to claim 3, further comprising
output capability information acquisition means for acquiring output capability information of the plurality of printers connected to the network, and
job output setting information acquisition means for acquiring output setting information of the print job,
wherein said redirect-on-error printer detection means detects, of the plurality of printers, a printer driver of a printer having a printer output capability which satisfies a condition of the acquired job output setting information, and
said redirect-on-error destination candidate notification means notifies the user, as the redirect-on-error destination candidate, of the printer driver detected by said redirect-on-error printer detection means.

8. The apparatus according to claim 3, wherein said condition input means further comprises
compatible level designation means for designating a compatible level of the printer driver of the redirect-on-error destination, and
said redirect-on-error printer detection means detects a printer driver which satisfies a condition about the compatible level designated by said compatible level designation means.

9. The apparatus according to claim 8, wherein the compatible level includes “perfect compatible” which indicates processing for detecting the redirect-on-error destination candidate in consideration of output setting of the printer with the print error and a print engine condition, and “simple compatible” which indicates processing for detecting the redirect-on-error destination candidate in consideration of one of the output setting and the print engine condition.

10. A control method of a redirect-on-error print system which transmits a print job to one of a plurality of printers connected to a network, and when a print error has occurred in the printer, executes processing to cause another printer to execute redirect-on-error printing of the print job, comprising:
an error detection step of detecting the error in the printer which is processing the print job;
an error notification step of notifying a user of the error;
a redirect-on-error printer detection step of detecting, of the plurality of printers connected to the network, a printer driver of a redirect-on-error enable printer which can process the print job in behalf of the printer with the error; and
a redirect-on-error destination candidate notification step of notifying the user, as a redirect-on-error destination candidate, of the printer driver detected in the redirect-on-error printer detection step.

11. A control program to control an information processing apparatus in a redirect-on-error print system which transmits a print job to one of a plurality of printers connected to a network, and when a print error has occurred in the printer, executes processing to cause another printer to execute redirect-on-error printing of the print job, comprising:
a code for executing an error recognition step of recognizing the error in the printer which is processing the print job;
a code for executing a condition input step of inputting a condition to detect, of the plurality of printers connected to the network, a printer driver of a redirect-on-error enable printer which should process the print job in behalf of the printer with the error;
a code for executing a redirect-on-error printer detection step of selectively detecting the printer driver of the redirect-on-error enable printer in accordance with the condition input in the condition input step;
a code for executing a redirect-on-error destination candidate notification step of notifying a user, as a redirect-on-error destination candidate, of the printer driver detected in the redirect-on-error printer detection step; and
a code for executing a selection step of selecting one redirect-on-error destination from the notified redirect-on-error destination candidates.

12. The program according to claim 11, wherein a type of the printer driver includes a first driver type which issues a print job having a format capable of respooling a predetermined document and a second driver type which issues a print job having a format incapable of respooling.

13. The program according to claim 12, wherein when the print job is issued by a printer driver belonging to the first driver type, in the redirect-on-error destination candidate notification step, the user is notified, as the redirect-on-error destination candidates, of all printer drivers belonging to the first driver type.

14. The program according to claim 12, wherein when the print job is issued by a printer driver belonging to the second driver type, in the redirect-on-error destination candidate notification step, the user is notified, as the redirect-on-error destination candidates, of only a printer driver using a print engine which can be regarded for a predetermined condition as the same as that of the printer with the error in accordance with the condition input in the condition input step.

15. The program according to claim 11, further comprising
a code for executing an output capability information acquisition step of acquiring output capability information of the plurality of printers connected to the network, and
a code for executing a job output setting information acquisition step of acquiring output setting information of the print job,
wherein in the redirect-on-error printer detection step, of the plurality of printers, a printer driver of a printer having a printer output capability which satisfies a condition of the acquired job output setting information is detected, and
in the redirect-on-error destination candidate notification step, the user is notified, as the redirect-on-error destination candidate, of the printer driver detected in the redirect-on-error printer detection step.

16. The program according to claim 11, wherein the condition input step further comprises a compatible level designation step of designating a compatible level of the printer driver of the redirect-on-error destination, and
in the redirect-on-error printer detection step, a printer driver which satisfies a condition about the compatible level designated in the compatible level designation step is detected.

17. The program according to claim 16, wherein the compatible level includes “perfect compatible” which indicates processing for detecting the redirect-on-error destination candidate in consideration of output setting of the printer with the print error and a print engine condition, and “simple compatible” which indicates processing for detecting the redirect-on-error destination candidate in consideration of one of the output setting and the print engine condition.
